(19) United States
(12) Patent Application Publication
(10) Pub. No.: US 2017/0361252 A1
(43) Pub. Date: Dec. 21, 2017

(54) Hollow Filter Element, Filter, and Housing Section of a Filter

(71) Applicant: MANN+HUMMEL GMBH, Ludwigsburg (DE)

(72) Inventors: Christian Vogt, Ludwigsburg (DE); Andreas Wildermuth, Marbach (DE); Mahdi Abokhalaf, Ludwigsburg (DE)

(21) Appl. No.: 15/624,804

(22) Filed: Jun. 16, 2017

(30) Foreign Application Priority Data
Jun. 16, 2016 (DE) 10 2016 007 298.9

(51) Int. Cl. B01D 35/30; B01D 29/11; B01D 35/00; B01D 35/147

(52) U.S. Cl. CPC B01D 35/30; B01D 35/147; B01D 29/11; B01D 35/005; B01D 2201/4015

(57) ABSTRACT

A hollow filter element of a fluid filter has a filter element-associated retention/carrier device of a retention/carrier system retaining the filter element in a first housing section of a filter housing during installation/removal in or from a second housing section by rotation and/or insertion movement. The filter element-associated retention/carrier device has a retention/carrier part extending radially and circumferentially and has through holes adjacent thereto extending circumferentially so as to enable a filter housing-associated retention/carrier part of the retention/carrier system to pass through axially. This retention/carrier part has a tensile face extending circumferentially and radially on a side facing away from an end face of the filter element facing the first housing section. This retention/carrier part has a rear side in circumferential direction. A space axially adjacent to the tensile face is connected on the rear side to a through hole for guiding through the filter housing-associated retention/carrier part.

### BACKGROUND OF THE INVENTION

The invention relates to a hollow filter element, in particular a round filter element, of a filter for fluid, in particular engine oil, fuel, water, hydraulic fluid, urea/water solution or air, in particular of an internal combustion engine, in particular of a motor vehicle, that can be exchangeably arranged in a filter housing of the filter, comprising at least one filter element-associated retention/carrier device of a retention/carrier system for retention on and/or carriage with a first housing section, in particular a housing cover, of the filter housing at least during an installation of the hollow filter element in a second housing section, in particular a housing pot, of the filter housing and/or a removal from the second housing section, wherein the hollow filter element can be brought together with the first housing section and/or the second housing section and be separated from it by a rotational and/or insertion movement with respect to a virtual axis.

The invention further relates to a filter for fluid, in particular engine oil, fuel, water, hydraulic fluid, urea/water solution or air, in particular of an internal combustion engine, in particular of a motor vehicle, comprising at least one hollow filter element, in particular round filter element, that is exchangeably arranged in an openable filter housing of the filter, wherein the filter housing has at least two housing sections, in particular a housing pot and a housing cover, that are at least partly separable from one another for opening the filter housing, wherein the first housing section has at least one housing side retention/carrier device and the at least one hollow filter element has at least one filter element-associated retention/carrier device of a retention/carrier system for retention of the at least one hollow filter element on and/or carriage of the at least one hollow filter element with the first housing section, at least during installation of the at least one hollow filter element in the second housing section and/or a removal from the second housing section, wherein the hollow filter element can be brought together with the first housing section and/or the second housing section and be separated from it by a rotational and/or insertion movement with respect to a virtual axis.

The invention further relates to a housing section, in particular housing cover, of a filter housing of a filter for fluid, in particular engine oil, fuel, water, hydraulic fluid, urea/water solution or air, in particular of an internal combustion engine, in particular of a motor vehicle, wherein the filter housing may be joined to at least a second housing section, in particular a housing pot, for sealing off the filter housing, and may be separated at least in part by at least one second housing section for opening the filter housing, wherein the housing section, in particular the housing cover, has at least one filter housing-associated retention/carrier device of a retention/carrier system for retention of at least one hollow filter element on and/or carriage of the at least one hollow filter element with the housing section, at least during an installation of the at least one hollow filter element in the second housing section and/or a removal from the second housing section, wherein the housing section, in particular the housing cover can be brought together with the hollow filter element and/or the second housing section and be separated from it by a rotational and/or insertion movement with respect to a virtual axis.

A fluid filter, in particular an oil filter for cleaning lubricating oil, in particular for internal combustion engines of motor vehicles, is known from DE 199 51 085 A1. The fluid filter in the installed state has an essentially upright mounted filter housing, which contains an accommodating space. The filter housing is tightly sealed on its top side with a screw-on cover. Mounted on the inside of the cover is a bracket that has a central ring and latch hooks axially projecting therefrom. The latch hooks are equipped with a radially projecting latch-in nose and are designed to be radially elastic. In the accommodating space of the filter housing, a ring filter insert is used that has a filter material arranged in an annular configuration. The ring filter insert has an inner frame provided with radial cutouts against which the filter can brace from outside. An annular collar is formed at the upper end of the inner frame that extends coaxially with respect to a longitudinal axis of the filter housing or of the ring filter insert. A radially inwardly projecting ring shoulder is configured axially inwardly adjacently on the annular collar and interacts with the latch hooks. When the filter insert is slipped onto the cover, the noses of the latch hooks on the annular shoulder latch onto the ring shoulder in a positive-locking manner. In this way, the ring filter insert is axially fixed on the cover on one side and is mounted freely rotatably about its longitudinal axis.

The object of the invention is to design a hollow filter element, a filter, and a housing section of the aforementioned kind in which an installation of the hollow filter element in the filter housing and/or removal from the filter housing can be realized more easily and in a manner which is gentler to the material, in particular gentler to the material of at least one existing seal.

### SUMMARY OF THE INVENTION

This object is achieved according to the invention by the at least one filter element-associated retention/carrier device having at least one filter element-associated retention/carrier part, which extends radially with respect to the axis and circumferentially over at least a portion of a radially inner circumference of the hollow filter element, wherein the at least one filter element-associated retention/carrier device has, circumferentially adjacent to the at least one filter element-associated retention/carrier part with respect to the axis, at least one through hole extending circumferentially with respect to the axis for at least one corresponding filter housing-associated retention/carrier part of at least one filter housing-associated retention/carrier device of the retention/carrier system, wherein the at least one filter element-associated retention/carrier part has a tensile face extending circumferentially and radially that is located on the side facing axially away from, with respect to the axis, an end face to be facing the first housing section, in particular a cover-side end face of the hollow filter element, wherein a space axially adjacent to the tensile face on the rear side—when viewed in a defined circumferential direction of the filter element—of the at least one filter element-associated retention/carrier part is connected to at least one through hole adjacent thereto in a manner suitable for guiding through the at least one filter housing-associated retention/carrier part.

Preferably, the at least one filter element-associated retention/carrier part on the side on which the tensile face is located has a limit stop that delimits the tensile face when viewed in the circumferential direction of the filter element.

Also preferably, the at least one filter element-associated retention/carrier device has a free-running annular space for the at least one filter housing-associated retention/carrier part extending circumferentially contiguously with respect to the axis; this space is located, when viewed in axial direction from the end face of the hollow filter element to be facing the first housing section, behind the at least one filter element-associated retention/carrier part and is connected to at least one through hole of the at least one filter element-associated retention/carrier device in a manner suitable for guiding through the at least one filter housing-associated retention/carrier part.

According to the invention, a retention/carrier system is provided with which the hollow filter element can be preinstalled and retained on/in the first housing section. In the assembly of the first housing section with the first housing section, the hollow filter element can be carried by the retention/carrier system. According to the invention, a positive-fit, in particular exclusively positive-fit, in particular bayonet-closure-type retention/carrier system that is connectable and separable and tension-loadable with respect to the axis is combined with a free run acting in the circumferential direction with respect to the axis.

For the preassembly, the hollow filter element can be moved forward axially with its corresponding end face toward a connection side of the first housing section so that the filter element-associated retention/carrier device is moved toward the filter housing-associated retention/carrier device. The hollow filter element can be turned relative to the first housing section counter to the circumferential direction of the filter element about the axis in such a way that the at least one filter housing-associated retention/carrier element is aligned with at least one through hole of the at least one filter element-associated retention/carrier device.

The hollow filter element can be moved in the direction of the first housing section by a corresponding insertion movement axially with respect to the axis. In this arrangement, the at least one filter housing-associated retention/carrier part is guided from the end face of the hollow filter element through the at least one through hole to the side of the at least one filter element-associated retention/carrier part that axially faces away from the end face of the hollow filter element with respect to the axis. In this context, no elastic forces, in particular spring-elastic forces, of the components of the retention/carrier system must be overcome, as is the case with the latching connection of the fluid filter that is known in the art.

By a rotational movement or combined rotational/insertion movement of the first housing section relative to the hollow filter element about the axis counter to the defined circumferential direction of the filter element or a rotational movement or rotational/insertion movement of the hollow filter element relative to the first housing section in the circumferential direction of the filter element, the filter housing-associated retention/carrier can be moved along against the tensile face of the filter element-associated retention/carrier up to the corresponding limit stop. The filter element-associated retention/carrier part and the filter housing-associated retention/carrier part can hook into each other in this state. The retention/carrier system can be axially tension-loaded so that the hollow filter element can be retained in/on the first housing section.

For the assembly of the filter, the first housing section with the hollow filter element retained therewith can be inserted into the second housing section in an axially forward direction. Thus, the first housing section can be moved axially with an insertion movement toward the second housing section.

The first housing section and the second housing section can advantageously be joined to each other by a rotatable and/or insertable housing connection, in particular a screw connection or bayonet-type connection. A screw connection is a rotational/insertion connection in which, because of a thread pitch from a rotational movement, an insertion movement or, when the connection is separated, a pulling movement results. A screw connection is thus realized by a combined rotational/insertion movement.

Due to a corresponding insertion movement or a combined rotational/insertion movement of the first housing section relative to the second housing section at least axially with respect to the axis, the at least one filter housing-associated retention/carrier element can be moved axially away from the tensile face of the filter element-associated retention/carrier device in the free-running annular space.

By a corresponding rotational movement or a combined rotational/insertion movement, in particular a screwing movement, of the first housing section relative to the second housing section in the circumferential direction of the filter element, the housing connection can be closed. Because the at least one filter housing-associated retention/carrier part is in the free-running annular space of the at least one filter element-associated retention/carrier device and can run freely therein in the circumferential direction relative to the hollow filter element, the hollow filter element is not carried in the rotary direction or combined rotational/insertion movement of the first housing section in the circumferential direction. The hollow filter element can remain in a rotationally fixed orientation in the second housing section, while the first housing section can be brought into its end position on/in the second housing section with the rotational movement or combined rotational/insertion movement in the closing rotational direction. The hollow filter element can be pressed merely axially, with respect to the axis, against the second housing section. In this way, it is possible to prevent any seal, in particular a ring seal that may be located between the hollow filter element and the second housing section, from rubbing against one of the components due to the relative movements of the two housing sections. The free-running action can reduce mechanical loading of the at least one seal, in particular due to abrasion. The sealing device, in particular the at least one seal, is protected.

Alternatively, the hollow filter element can first be inserted into the second housing section by an insertion movement. Then the first housing section can be joined to the second housing section. In this arrangement, the at least one filter housing-associated retention/carrier device and the at least one filter element-associated retention/carrier device can accordingly be connected with each other.

To remove the hollow filter element, the first housing section can be moved counter to the closing rotational direction of the housing joint and counter to the circumferential direction of the filter element relative to the second housing section to separate it from the second housing section by a rotational movement or a combined rotational/pulling movement. In this process, the at least one filter housing-associated retention/carrier part and the at least one filter element-associated retention/carrier part can hook into each other. The retention/carrier system can thus be activated and is axially tension-loadable with respect to the axis. The limit stop of the at least one filter element-associated retention/carrier element can also mechanically load the retention/carrier system with respect to the rotation counter to the circumferential direction of the filter element. In this way, the hollow filter element can be carried along with the first housing section during the separation from the second housing section.

Overall, for removal from the second housing section, the hollow filter element can be moved by means of the retention/carrier system relative to the second housing section with respect to the axis, depending on the removal phase, by a rotational movement, a pulling movement or a combined rotational/pulling movement.

The retention/carrier system according to the invention has, on the one hand, the advantage that the mechanical forces that act on the retention/carrier elements for closure or separation of the connection are smaller than in the case with the latch hooks of the known fluid filter of the prior art. In this way, wear and fatigue of the involved components may be reduced. A nearly force-free, in particular exclusively positive-locking connection and separation between hollow filter element and the first housing section is possible. On the other hand, greater entrainment forces between the first housing section and the hollow filter element can be transferred compared in particular to the latch hooks known from the prior art.

Furthermore, the retention/carrier system according to the invention can be separated more easily than the known latch hooks. No additional tools are required for this.

Advantageously, the virtual axis may coincide with a housing axis of the filter housing, an installation/removal axis of the hollow filter element into/out of the first housing section and/or second housing section, a connection axis of the first housing section with the second housing section and/or an element axis of the hollow filter element, or be identical to it/them. The hollow filter may, on the one hand, be brought together with the first housing section by corresponding rotational and/or insertion movements with respect to the virtual axis and, on the other hand, be brought together with the second housing section with corresponding rotational and/or insertion movements and be separated from it/them by corresponding rotational and/or pulling movements.

Advantageously, when the hollow filter element is installed in/on at least one of the housing sections, the circumferential direction of the filter element can be oriented in the direction of a connection rotational direction, in particular a closing rotational direction, of the rotational and/or insertion movement for bringing together the first housing section and the second housing section.

Advantageously, the at least one filter housing-associated retention/carrier section in the joined state of the carrier system can operatively abut, in particular hook into, the limit stop of the at least one filter element-associated retention/carrier part counter to the circumferential direction of the filter element, in particular counter to the connection rotational direction.

Advantageously, the at least one filter housing-associated retention/carrier device and/or the at least one filter element-associated retention/carrier device, in particular at least one filter housing-associated retention/carrier part and/or at least one filter element-associated retention/carrier part, may be made of plastic or comprise plastic. Plastic can easily be molded.

Advantageously, the at least one filter housing-associated retention/carrier device and/or the at least one filter element-associated retention/carrier device, in particular at least one filter housing-associated retention/carrier part and/or at least one filter element-associated retention/carrier part, may be detachably or non-detachably joined to the filter medium.

A hollow filter element may have at least one element interior space that is surrounded by a filter bellows with a filter medium. It is possible for the fluid to be filtered to flow through the filter medium from outside to inside to the element interior space or vice versa. The at least one element interior space has at least one fluid passage on the outside through which, depending on the direction of flow, the filtered fluid can leave the element interior space or the fluid to be filtered can enter it. The filter medium can circumferentially surround the element interior space with respect to the axis, in particular the element axis. The filter medium can be joined to an axial end face with respect to the axis by an end body, in particular an end plate. At least one end body may have a passage opening for the element interior space. Alternatively, the at least one end body may have a receiving opening for a bypass valve, or at least partially form it.

The hollow filter element may advantageously be a round filter element having a round cross-section, an oval round filter element having an oval cross-section, a flat-oval round filter element having a flattened oval cross-section, a conical round filter element in which the round cross-section tapers in the axial direction with respect to a main axis, a conical oval round filter element in which the oval cross-section tapers in the axial direction, at least in the direction of a transverse axis, a conical flat-oval round filter element in which the flat-oval cross-section tapers in the axial direction, at least in the direction of a transverse axis, or a hollow filter element having a different type, in particular polygonal, cross-section and/or a different type of axial cross-sectional profile in the direction of the element axis.

The filter medium may advantageously be circumferentially closed or open with respect to the axis. The filter medium can in particular be star-shaped, preferably zig-zag shaped or wave shaped, folded or curved. The filter medium can also be not folded or not curved.

The filter element may advantageously be part of an engine oil filter of an engine oil circuit of an internal combustion engine of a motor vehicle. It may be used for the filtering of engine oil that is supplied to the internal combustion engine. However, the invention is not limited to an engine oil filter of an engine oil circuit of an internal combustion engine of a motor vehicle. On the contrary, it may also be used in other fluid systems, in particular fuel systems, hydraulic systems or air systems of motor vehicles or other machines. The filter may also be used outside of motor vehicle technology, in particular, with industrial engines. The filter may also be arranged as an air filter in an air intake conduit of an internal combustion engine.

In an advantageous embodiment, the at least one filter element-associated retention/carrier part on its—when viewed in the circumferential direction of the filter element—front side may have a free-running guide for guiding the at least one filter housing-associated retention/part from the at least one through-hole adjacent thereto into a free-running annular space and/or vice-versa.

Advantageously, the free-running guide is realized on/with the limit stop of the at least one filter element-associated retention/carrier part.

The free-running guide may be arranged on the side of the limit stop that faces away from the at least one tensile face. In this way, the free-running guide may be used to prevent the at least one filter housing-associated retention/carrier part, after a corresponding further rotation of the hollow filter element relative to the first housing section, from passing from this side into the space behind the tensile face and re-attaching with the at least one filter element-associated retention/carrier part.

In another advantageous embodiment, the at least one filter element-associated retention/carrier device, in particular the at least one filter element-associated retention/carrier part, may be arranged at least partially in the element interior space of the hollow filter element and so as to be accessible from the exterior of the hollow filter element. In this way, the at least one filter element-associated retention/carrier device, in particular the at least one filter element-associated retention/carrier part, may be arranged in the element interior space in a space-saving and/or protected manner. It is not absolutely necessary to arrange, in particular to attach, the at least one filter element-associated retention/carrier device, in particular the at least one filter element-associated retention/carrier part, on an end body, in particular an end plate, of the hollow filter element. The retention/carrier system can in this way be realized both in connection with hollow filter elements that have an end body and with hollow filter elements without end bodies.

In another advantageous embodiment, the at least one filter element-associated retention/carrier device, in particular the at least one filter element-associated retention/carrier part, may be connected directly, in particular integrally formed or formed by a plurality of pieces, or indirectly, in particular by connection means, detachably or in a non-destruction-free-detachment manner, to a supporting element such as a support body, in particular a support tube, and/or to an end body, in particular an end plate, of the hollow filter element and/or to a carrier part, in particular a carrier ring. In this way retention forces and/or connecting forces may be transmitted from the retention/carrier system directly to the support bodies and/or the end bodies. A mechanical loading of the filter medium by the retention forces and/or connecting forces can thereby be prevented. In this way, the hollow filter element may be held more stably and more reliably in the filter housing.

The at least one filter element-associated retention/carrier part may be realized in or on the carrier part. The carrier part can be arranged in a space-saving and/or protected manner at least partially inside the element interior space of the hollow filter element. Advantageously, the carrier part may be a carrier ring. The carrier ring may advantageously be arranged coaxially with respect to the axis.

Advantageously, at least one filter element-associated retention/carrier part may be realized as one piece together with the support body and/or the end body and/or the carrier body, in particular in plastic.

According to another embodiment, the carrier ring, on which the filter element-associated retention/carrier device, in particular the at least one filter element-associated retention/carrier part, is disposed, is designed as a collar. The collar may be joined to the at least one end body, in particular at least one end plate, detachably or non-detachably, for example, glued or welded thereto or clipped into them. A collar-type carrier ring in this context means a carrier ring that has a cylindrical section for insertion in an element interior space and a plate-like section for the attachment to the at least one end body, preferably an end plate. A design of the filter element-associated retention/carrier device, in particular of the at least one filter element-associated retention/carrier, on a carrier ring configured in this manner has the advantage that even filter elements that do not have injection-molded plastic end plates, but instead have, for example, end plates made of a foamed plastic material may be outfitted with a filter element-associated retention/carrier device of the functional principle on which the invention is based. This is a very economical variant, because filter element and carrier ring may be manufactured completely independently of each other and the possibility also exists, as in the case of a modular construction system, of using one carrier ring for a plurality of various filter elements.

According to yet another embodiment, the carrier ring, on which the filter element-associated retention/carrier device, in particular the at least one filter element-associated retention/carrier part, is present, is designed as a collar. In this embodiment, the carrier ring may further be joined, in particular detachably or non-detachably, in particular glued, to at least one end body, in particular at least one end plate. This has the advantage that the retention/carrier system on which the invention is based may be attached simply and economically to filter elements; no complex injection molds are necessary for the end plates in order to accomplish this.

Furthermore, it may be provided that the filter element-associated retention/carrier device, in particular the at least one filter element-associated retention/carrier part, is present on a retention/carrier ring rotatably mounted on the radially inward circumference, in particular in the element interior space, of the hollow filter element. The retention/carrier ring is a component that is separate from the carrier ring and/or center tube and that is relatively rotatable. The retention/carrier ring provides that the hollow filter element is not always co-rotated when the housing cover on which the filter housing-associated retention/carrier device is disposed is screwed in; rather, it is merely axially pushed against a sealing seat.

In connection with the retention/carrier ring, it may further be provided that it is held in a circumferential groove on an interior face of the central tube or of the carrier ring and/or is rotatable with respect to the center tube or the carrier ring only after overcoming a prescribed limiting torque. This is achievable in the functional contact by selection of a suitable fit and/or the surface properties. Moreover, a radially expanding ring, such as a snap ring, may be provided that produces an additional clamping force, which may have advantages when a relaxation of an employed plastic material occurs.

In another advantageous embodiment, the at least one filter element-associated retention/carrier part may be a component of a bayonet-closure-type retention/carrier system. A bayonet-closure-type retention/carrier system may easily and quickly be connected and detached again by a combined rotational/insertion movement. Moreover, a bayonet-closure-type retention/carrier system may be loaded with tensile forces in the direction of the connection axis, in particular the element axis.

A bayonet-closure-type retention/carrier system may be designed in such a way that it is connected or separated exclusively by positive-locking action and may transmit tensile forces effecting the positive lock axially with respect to the axis. No elastic deformations of the components are required as is required in the case of the latch hooks of the fluid filter known from the prior art. In this way, the components involved may be protected. Fatigue and/or wear of the material may be reduced in this way.

In another advantageous embodiment, at least two, preferably three (or more), filter element-associated retention/carrier parts are arranged in an even or uneven distribution around the circumference with respect to the axis, in particular the element axis. In this way, the retention forces and/or connecting forces may be better—in particular more evenly—transmitted between the filter element-associated retention/carrier device and the filter housing-associated retention/carrier device.

Accordingly, at least two, preferably three, filter housing-associated retention/carrier parts may advantageously be arranged on the first housing section in an even or uneven distribution around the circumference with respect to the axis, in particular the housing axis.

In another advantageous embodiment, the at least one filter element-associated retention/carrier part on a side facing axially away from the at least one tensile face with respect to the axis may comprise or realize a guide surface, in particular a guide ramp, for guiding at least one filter housing-associated retention/carrier part for mating of the first housing section and the hollow filter element, With the at least one guide surface, the at least one filter housing-associated retention/carrier part can be guided more easily to the corresponding at least one through hole during the mating of the hollow filter element and the first housing section.

In another advantageous embodiment, when viewed in the circumferential direction of the filter element, an axial distance, with respect to the axis of the at least one guide surface, may increase relative to the adjacent end face of the hollow filter element. In this way, the guide surface may have a slope, that is, it may be configured as a ramp surface.

According to an alternative embodiment, the at least one filter element-associated retention/carrier part or the at least one filter housing-associated retention/carrier part may have an essentially radially extending pin and the other respective part of the retention/carrier system, that is, the filter element-associated or filter housing-associated retention/carrier part, may have a receptacle groove extending in the radial direction that corresponds to an outer contour of the pin. A design of the retention/carrier system with the pin and receptacle groove as cooperating components has the advantage that, primarily in the case of a filter element-associated arrangement of the pin on a center tube or carrier ring, it may be manufactured more economically than ramps because it is geometrically easier to demold, specifically due to a comparatively easy to realize rotary slide.

According to a preferred further embodiment, it is provided that the at least one filter element-associated or filter housing-associated retention/carrier part, which has the receptacle groove, has at least one clamping surface axially spaced apart from the receptacle groove. In particular, it may be provided that the receptacle groove is present on a receptacle body and the clamping surface on a clamping body that is configured separately from the receptacle body. In this arrangement, clamping bodies and receptacle bodies may be axially spaced apart from each other at a suitable distance. In this arrangement, the pin may be accommodated between receptacle groove and clamping surface so that, in addition to a tensile force, a torque may be transmitted.

The two previously described embodiments are especially well suited with an implementation of the free-running property on the part of the bypass valve or by the previously described retention/carrier ring, but are not limited to these embodiments.

The slope of the at least one guide surface, at least with respect to its slope direction, may correspond to the slopes of connecting parts, in particular threads, of a rotational and/or plug-in connection, in particular a screw connection, between the first housing section and the second housing section. The slope direction of the at least one guide surface and/or the connecting parts may correspond to a standard right-hand thread. The pitch of the at least one guide surface and the connecting parts may be the same or different.

In another advantageous embodiment, the at least one filter element-associated retention/carrier part may be realized in the vicinity of, on or together with a valve seat for holding in particular a bypass valve and/or in the vicinity of, on or together with a bypass valve, in particular a housing of the bypass valve. In this way, the valve seat and/or the bypass valve may be realized together with at least one filter element-associated retention/carrier part. In this way, component expenses, manufacturing efforts, installation efforts and/or space requirements may be reduced.

Alternatively or additionally, at least one filter housing-associated retention/carrier part may advantageously be realized in the vicinity of, on or together with a valve seat for holding in particular a bypass valve and/or in the vicinity of, on or together with a bypass valve.

The bypass valve may advantageously be opened for bypassing the filter medium, in particular in the case of undesirably high pressure differences between the unfiltered fluid side and the clean fluid side. Pressure differences of this type may in particular result when there is a blockage of the filter medium. By opening the bypass valve, a bypass for getting around the filter medium can be enabled.

The bypass valve may protrude at least partially into the element internal space when the filter is installed. In the closed state, it can seal an opening of the element internal space provided thereat. In the opened state, the bypass valve can connect the unfiltered fluid side of the hollow filter element to the element interior space.

Furthermore, the technical object is achieved for the filter according to the invention by the at least one filter element-associated retention/carrier device having at least one filter element-associated retention/carrier part, which extends radially with respect to the axis and circumferentially over a portion of a circumference, in particular a radially inner circumference of the hollow filter element, wherein the at least one filter element-associated retention/carrier device has, circumferentially adjacent to the at least one filter element-associated retention/carrier part with respect to the axis, at least one through hole extending circumferentially with respect to the axis for at least one corresponding filter housing-associated retention/carrier part of at least one housing side retention/carrier device of the retention/carrier system, wherein the at least one filter element-associated retention/carrier part has a tensile face extending circumferentially and radially that is located on the side facing axially away from, with respect to axis, an end face to be facing the first housing section, in particular a cover-side end face of the hollow filter element, wherein a space axially adjacent to the tensile face on the rear side—when viewed in a defined circumferential direction of the filter element—of the at least one filter element-associated retention/carrier part is connected to at least one through hole adjacent thereto in a manner suitable for guiding through the at least one filter housing-associated retention/carrier part,

Preferably, the at least one filter element-associated retention/carrier part on the side on which the tensile face is located has a limit stop that delimits the tensile face when viewed in the circumferential direction of the filter element.

Also preferably, the at least one filter element-associated retention/carrier device has a free-running annular space for the at least one filter housing-associated retention/carrier part extending circumferentially contiguously with respect to the axis that is located, when viewed axially relative to the axis from the end face of the hollow filter element to be facing the first housing section, behind the at least one filter element-associated retention/carrier part and that is connected to at least one through hole of the at least one filter element-associated retention/carrier device in a manner suitable for guiding through the at least one filter housing-associated retention/carrier part.

According to a further embodiment of the filter according to the invention, it may be provided that the housing cover has a bypass valve that comprises a bypass valve housing. The at least one filter housing-associated retention/carrier device, in particular the at least one filter housing-associated retention/carrier part, is disposed in this arrangement on the bypass valve housing. For example, the filter housing-associated retention/carrier device, in particular the at least one filter housing-associated retention/carrier part, may be disposed on a radially outer surface of the bypass valve housing.

Finally, it may be provided that the bypass valve housing is rotatable relative to the housing cover, preferably only after a prescribed limiting torque is overcome. The rotatability of the bypass valve housing with respect to the housing cover has the technical effect that it enables a free running of the filter housing-associated retention/carrier device with respect to the filter element-associated retention/carrier device. The free running only takes effect if a limiting torque is exceeded. The countertorque, which ultimately results in overcoming the limiting torque, is produced in the cooperation of a filtered/unfiltered seal present, for example, in the area of the bottom end plate. In particular in the case of embodiments that employ a radial seal for this sealing function, considerable torque is produced by friction in the area of the sealing surface(s) as a function of the seal diameter.

However, the limiting torque selected must not be too small because, otherwise, when the housing cover is released (in a special embodiment, this corresponds to opening) from the housing pot, the filter housing-associated retention/carrier device could not be brought into operative engagement with the filter element-associated retention/carrier device; in particular, it would not be ensured that the filter housing-associated retention/carrier parts plunge under the tensile faces of the filter element-associated retention/carrier parts in order to be able to exert a pulling force on the element, as previously described.

The bypass valve housing may be detachably joined to the housing cover, for example, by a snap connection with at least one latch nose, preferably with two or more latch noses distributed over the circumference of the bypass valve housing, wherein the aforementioned limiting torque may be advantageously determined by the prestress force of the latch noses and the quantity of them.

Furthermore, the technical object is achieved for the housing section according to the invention by the at least one filter housing-associated retention/carrier device having at least one filter housing-associated retention/carrier part, which extends radially with respect to the axis and circumferentially over at least a portion, wherein the at least one filter housing-associated retention/carrier device, relative to the axis circumferentially adjacent to the at least one filter housing-associated retention/carrier part, comprises at least one gap, extending circumferentially with respect to the axis, for at least one corresponding filter element-associated retention/carrier part of at least one filter element-associated retention/carrier device of the retention/carrier system, wherein the at least one filter housing-associated retention/carrier device, in particular at least one filter housing-associated retention/carrier part is realized on or in connection with a bypass valve of the oil filter.

Advantageously, the bypass valve can be attached to the housing section, in particular the housing cover. The bypass valve may advantageously be configured coaxially with respect to the axis.

The housing cover is preferably comprised of a plurality of parts.

Moreover, the features and advantages demonstrated in connection with the hollow filter element according to the invention, the filter according to the invention, and the housing section according to the invention, and their respective advantageous embodiments are mutually applicable, mutatis mutandis. The individual features and advantages may of course be combined with each other, wherein additional advantageous effects can be produced that go beyond the sum of the individual effects.

### BRIEF DESCRIPTION OF THE DRAWINGS

Other advantages, features, and details of the invention shall be made more apparent by the following description, which addresses an exemplary embodiment of the invention in greater detail with reference to the drawing. A person skilled in the art will expediently consider the features disclosed in combination in the drawing, the description, and the claims also individually and combine them into useful further combinations.

FIG. 1 shows a longitudinal section of an oil filter for engine oil of an internal combustion engine having a filter housing in which a filter element is installed by way of a retention/carrier system.

FIG. 2 is an isometric view of the filter element of FIG. 1 with a view toward a cover-side end face on which a filter element-associated retention/carrier device of the retention/carrier system is realized.

FIG. 3 is a longitudinal section of the housing cover with the filter element of the oil filter of FIG. 1 without the housing pot, wherein the retention/carrier system in this case is still separated.

FIG. 4 is a longitudinal section of the housing cover with the filter element of the oil filter of FIG. 1 in an assembly phase following the separated state of FIG. 3.

FIG. 5 is a longitudinal section of the housing cover with the filter element of the oil filter of FIG. 1 in an assembly phase during the installation of the housing cover with the filter element in the housing pot, wherein the housing pot is not depicted here.

FIG. 6 is a longitudinal section of a filter element according to a further embodiment having a carrier ring connected to the top end plate.

FIG. 7 is a longitudinal section of a filter element according to a further embodiment having a carrier ring connected to the top end plate and retention/carrier ring rotatably mounted therein.

FIG. 8 is a top view of a filter element according to a further embodiment.

FIG. 9 is a longitudinal section of an oil filter for engine oil of an internal combustion engine with the filter element of FIG. 8.

FIG. 10 is a longitudinal section of an oil filter for engine oil of an internal combustion engine having the filter element of FIG. 6.

FIG. 11 is an isometric view of a bypass valve of a filter according to the invention.

FIG. 12 is an isometric view of a hollow filter element according to yet another embodiment.

In the drawings, like components are assigned like reference signs.

### DESCRIPTION OF PREFERRED EMBODIMENTS

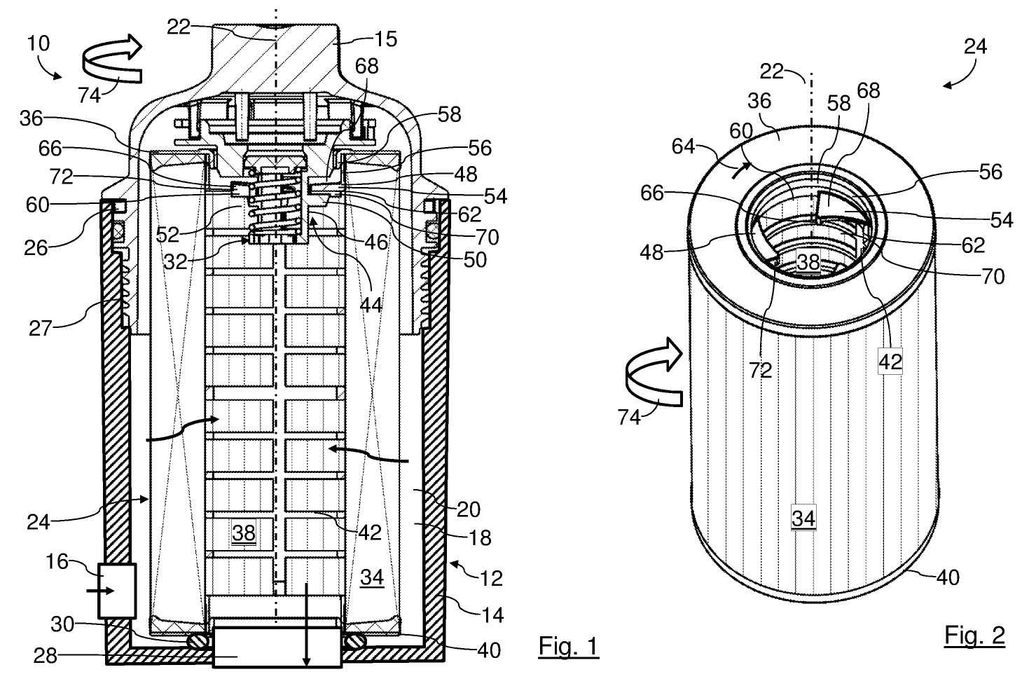

In FIG. 1, an oil filter 10 for engine oil of an engine oil circuit of an internal combustion engine of a motor vehicle is depicted in a longitudinal section.

The oil filter 10 includes a filter housing 12 having a housing pot 14, which is closable with a housing cover 15. The housing pot 14 is fixedly joined to the internal combustion engine or a frame part of the motor vehicle.

The housing pot 14 has an inlet 16 for engine oil to be filtered. The inlet 16 is joined to the engine oil circuit. The inlet 16 opens out into an unfiltered-oil-side inlet space 18 of the housing pot 14.

A housing interior space 20 of the filter housing 12 is coaxial with a virtual axis 22. The housing interior space 20 serves as the installation space for a filter element 24.

The axis 22 coincides in the exemplary embodiment with a housing axis of the filter housing 12, an installation/removal axis of the filter element 24 into/out of the housing pot 14, and an element axis of the filter element 24. The filter element 24 can be brought together, with respect to the virtual axis 22, with the housing cover 15, on the one hand, and the housing pot 14, on the other hand, by combined rotational/insertion movements and be separated from them accordingly by combined rotational/insertion movements. For the sake of better understanding, the element axis, the housing axis and the installation/removal axis are identified with the same reference number 22 in the following and are designated for short as axis 22. It is understood that, depending on context, the housing axis, the element axis and/or the installation/removal axis is intended. Subsequent discussion of “radial,” “coaxial,” “axial,” “circumferential,” and the like is made with respect to the axis 22, unless otherwise indicated.

On an end face facing the housing cover 15, the housing pot 14 has a coaxial installation opening 26 for the filter element 24. In the operation-ready state, the installation opening 26 is closed off by housing cover 15, as shown in FIG. 1. The housing cover 15 is connected to the housing pot 14 by a screw connection 27. For this purpose, the housing cover 15 has on its radially outer circumferential side a coaxial male thread that corresponds to a corresponding coaxial female thread of the housing pot 14. The threads in the described exemplary embodiment are so-called right-hand threads.

A coaxial outlet 28 leads out of the housing pot 14 at the bottom. The outlet 28 is joined outside of the filter housing 12 to the engine oil circuit.

A coaxial ring seal 30 is arranged between a bottom wall of the housing pot 14 and the filter element 24. The ring seal 30 is located on the filter element 24.

The housing cover 15 carries a bypass valve 32, which is coaxially attached to the inside of the housing cover 15.

The filter element 24 is exchangeably arranged in the filter housing 12 so as to separate the inlet 16 from the outlet 28.

The filter element 24, which is shown in detail in FIG. 2, is designed as a so-called round filter element. It has a zig-zag-shaped, circumferentially enclosed filter medium 34 in the form of a non-woven filter pad. On its cover-side end face axially facing the housing cover 15, the filter medium 34 is tightly connected to a ring-shaped, cover-side end plate 36. The bypass valve 32 projects through the coaxial opening of the cover-side end plate 36 in the correct installation state, as shown in FIG. 1.

The bypass valve 32 closes off a coaxial element internal space 38 of the filter element 24 on the cover-side end face during normal operation. The element-internal space 38 is circumferentially surrounded by the filter medium 34. A radially outer circumferential side of the filter medium 34 forms an inflow side for the engine oil (unfiltered oil) to be filtered on the unfiltered oil side. A radially inner circumferential side of the filter medium 34 forms an outflow side for the filtered engine oil (clean oil) on the filtered oil side of the filter element 24.

On the pot-side end face axially facing away from the housing cover 15, the filter medium 34 is tightly connected to a pot-side end plate 40. The pot-side end plate 40 is configured in a ring shape having a coaxial outlet opening. The outlet opening is fluidically connected in the installed state to the outlet 28 of the filter housing 12.

The end plates 36 and 40 are made of plastic. They may be foamed, glued, welded or otherwise connected in a sealing manner to the filter medium 34.

In the element interior space 38, a support tube 42 made of plastic coaxially extends between the end plates 36 and 40. At the radially outer circumferential side of the support tube 42, the filter medium 34 can be braced with its radially inner circumferential side. The support tube 42 is joined at its respective ends to the end plates 36 and 40. The circumferential wall of the support tube 42 is permeable to engine oil. The support tube 42 can also be clamped only between the end plates 36 and 40 or mounted in a floating manner.

The oil filter 10 further includes between the filter element 24 and the housing cover 15 a bayonet-closure-type retention/carrier system 44 for holding the filter element 24 on the housing cover 15 in the case of a preassembly and for carrying the filter element 24 with the housing cover 15 when the filter element 24 is installed in the housing pot 14 and removed from housing pot 14. The retention/carrier system 44 includes a filter housing-associated retention/carrier device 46 on the side of the housing cover 15 that can be detachably joined to a filter element-associated retention/carrier device 48 on the side of the filter element 24.

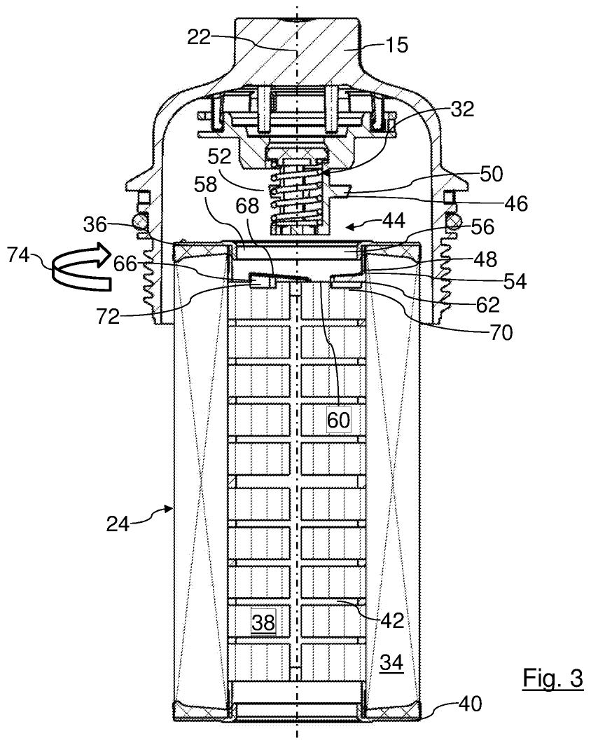

The filter housing-associated retention/carrier device 46 is made of plastic. The filter housing-associated retention/carrier device 46 has a total of three filter housing-associated retention/carrier parts 50 that are essentially identical in shape and size, only one of which is recognizable in FIGS. 1 and 3 to 5 because of the choice of the section plane. The filter housing-associated retention/carrier parts 50 are arranged evenly distributed around the circumference. The filter housing-associated retention/carrier parts 50 each extend radially outward and circumferentially over a portion of the radially outer circumference of the bypass valve 32. The filter housing-associated retention/carrier parts 50 are integrally formed on a housing of the bypass valve 32 and in this way are realized together with the bypass valve 32.

Between each two adjacent filter housing-associated retention/carrier parts 50, gaps 52 extending circumferentially are realized through which corresponding filter element-associated retention/carrier parts 54 of the filter element-associated retention/carrier device 48 can be guided axially.

The filter element 24 comprises the filter element-associated retention/carrier device 48 of the retention/carrier system 44. The filter element-associated retention/carrier device 48 is made of plastic. It has a carrier ring 56 on whose radially inner circumferential side the three filter element-associated retention/carrier parts 54 are each integrally formed thereon. The carrier ring 56 having the filter element-associated retention/carrier parts 54 is located in the vicinity of the cover-side end plate 36 in the element interior space 38. The carrier ring 56 having the filter element-associated retention/carrier parts 54 is accessible from the exterior through the opening of the cover-side end plate 36. The carrier ring 56, and with it the filter element-associated retention/carrier parts 54, are integrally formed on the support tube 42 of the filter element 24 and in a non-destruction-free-separation manner. The carrier ring 56 also forms a filter element-associated valve seat 58 for the bypass valve 32. The element side retention/carrier parts 54 are also realized on the valve seat 58.

The element side retention/carrier parts 54 are essentially identical in shape and size. They are arranged evenly distributed around the circumference. The filter element-associated retention/carrier parts 54 extend radially and circumferentially over a portion of the radially inner circumferential side of the support ring 56 and, thus, of the filter element 24.

The filter element-associated retention/carrier device 48 also has three through holes 60 that are essentially identical in shape and size. The through holes 60 are each located circumferentially adjacent to the filter element-associated retention/carrier parts 54, that is, between two circumferentially adjacent, filter element-associated retention/carrier parts 54. The through holes 60 each extend circumferentially over a portion of the radially inner circumferential side of the carrier ring 56 and, therefore, also of the filter element 24.

The through holes 60 are used for guiding through the filter housing-associated retention/carrier parts 50 of the filter housing-associated retention/carrier device 46 in the axial direction during the preassembly of the filter element 24 in the housing cover 15 and during the separation of the filter element 24 from the housing cover 15.

Each filter element-associated retention/carrier part 54 has a tensile face 62 extending circumferentially and radially. The tensile faces 62 are located on the side of the respective filter element-associated retention/carrier parts 54 axially facing away from the cover-side end face of the filter element 24.

A space axially adjacent to each tensile face 62 is, when viewed in a defined circumferential direction 64 of the filter element 24, on the rear side of the corresponding filter element-associated retention/carrier part 54, is connected to the through hole 60 adjacent thereto. The circumferential direction 64 of the filter element 24 is indicated in FIG. 2 by an arrow.

The filter element-associated retention/carrier parts 54 each have a limit stop 66 on their axial sides on which the tensile faces 62 are located. The limit stops 66 each delimit the corresponding tensile face 62 on the front side when viewed in the circumferential direction 64 of the filter element 24. The limit stops 66 each extend radially and axially.

The filter element-associated retention/carrier parts 54 further include a filter element-associated guide ramp 68 on a side facing axially away from the filter element-associated tensile face 62. An axial spacing of a guide surface of the guide ramp 68 relative to the cover-side end face of the filter element 24 increases when viewed in the circumferential direction 64 of the filter element 24. A slope of the guide ramp 68 corresponds, with respect to its slope direction, to the slopes of the female thread and the male thread of the screw connection 27 between the housing cover 15 and the housing pot 14. The slope directions of the guide ramp 68 and the female/male thread of the screw connection 27 correspond in the described exemplary embodiment to a standard right-hand thread. The pitch of the guide ramp 68 of the female/male thread may be identical or different.

The guide ramps 68 serve to guide the filter housing-associated retention/carrier parts 50 when the housing cover 15 and the filter element 24 are brought together. With the guide ramps 68, the housing side retention/carrier parts 50 can be guided to the nearest through hole 60 when the parts are brought together.

The filter element-associated retention/carrier device 48 also has a free-running annular space 70 for the filter housing-associated retention/carrier parts 50 that is extending circumferentially contiguously. The free-running annular space 70 is located, when viewed axially from the cover-side end face of the filter element 24, behind the filter element-associated retention/carrier parts 54. The free-running annular space 70 is connected to the through holes 60 for passage of the filter housing-associated retention/carrier parts 50. The through holes 60 therefore transition into the free-running annular space 70.

Each of the filter element-associated retention/carrier parts 54 on its—when viewed in the circumferential direction 64 of the filter element 24—front side has a free-running guide 72. The free-running guides 72 are each realized on the limit stops 66 of the corresponding filter element-associated retention/carrier parts 54. The free-running guides 72 are used to guide the housing side retention/carrier parts 50 from the adjacent through holes 60 into the free-running annular space 70 and vice-versa.

For the preassembly, the filter element 24 with its cover-side end plate 36 is moved axially forward to the inside of the housing cover 15. The bypass valve 32 is introduced into the valve seat 58, wherein the filter element-associated retention/carrier device 48 is moved toward the filter housing-associated retention/carrier device 46. The circumferential direction 64 of the filter element 24 is directed in the direction of a closing rotational direction 74 of the screw connection 27 of the housing cover 15 with the housing pot 14.

The filter element 24 is turned relative to the housing cover 15 counter to the circumferential direction 64 about the axis 22 until the filter housing-associated retention/carrier parts 50 each align with one of the through holes 60 of the filter element-associated retention/carrier device 48. In this position, the filter housing-associated retention/carrier parts 50 may glide along against the guide ramps 68 of the respective filter element-associated retention/carrier parts 54 and are guided with them.

The filter element 24 is further inserted into the housing cover 15 by a corresponding axial insertion movement. In this arrangement, the housing side retention/carrier parts 50 are each guided through the corresponding through holes 60 onto the side of the corresponding filter element-associated retention/carrier parts 54 that faces axially away from the cover-side end face of the filter element 24

By a rotational movement of the filter element 24 relative to the housing cover 15 in the circumferential direction 64 of the filter element 24, the filter housing-associated retention/carrier parts 50 are moved on the tensile faces 62 of the filter element-associated retention/carrier parts 54 up to their limit stops 66. The filter housing-associated retention/carrier parts 50, in the connected state of the retention/carrier system 44, operatively hook in behind the tensile faces 62 and against the limit stops 66 of the corresponding filter element-associated retention/carrier parts 54 counter to the circumferential direction 64 of the filter element 24 and counter to the closing rotational direction 74 of the screw connection 27 of the housing cover 15 with the housing pot 14. This assembly phase is shown in FIG. 4. The retention/carrier system 44 can be axially tension-loaded so that the filter element 24 can be retained in the housing cover 15. The filter housing-associated retention/carrier device 46 is detachably joined to the support tube 42, the cover-side end plate 36, the carrier ring 56, and the filter medium 34.

To assemble the oil filter 10, the housing cover 15 is inserted axially forward into the housing pot 14 along with the filter element 24 retained therein. In this arrangement, the housing cover 15 is first inserted by an axial insertion movement into the housing pot 14.

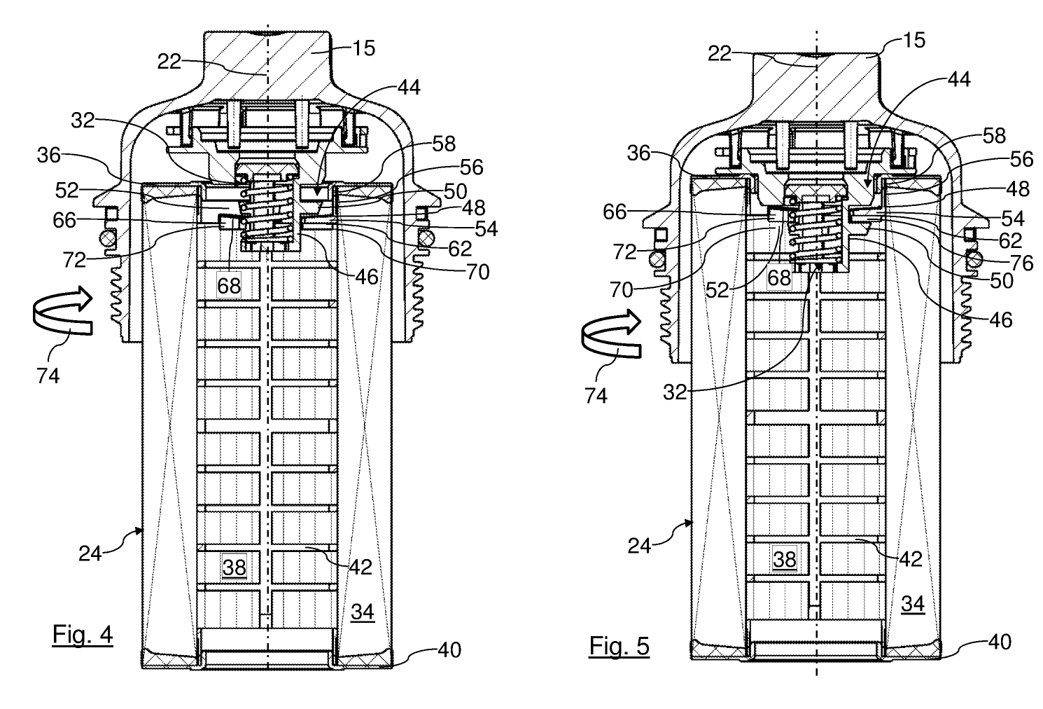

The housing cover 15 is joined to the housing pot 14 by a screwing movement in the closing rotational direction 74, that is, also in the circumferential direction 64 of the filter element 24. By a combined rotational/insertion movement of the housing cover 15 relative to the housing pot 14 in axial and circumferential direction resulting from the screwing movement, the filter housing-associated retention/carrier parts 50 are moved, on the one hand, circumferentially away from the limit stops 66 in the direction of the free-running guides 72 and, on the other hand, axially away from the tensile faces 62 of the filter element-associated retention/carrier parts 54 into the free-running annular space 70. With the free-running guides 72, the filter housing-associated retention/carrier parts 50 are guided into the free-running annular space 70. This assembly phase is shown in FIG. 5.

By continuing the screwing movement of the housing cover 15 relative to the housing pot 14 in circumferential direction 64 of the filter element 24, the screw connection 27 is closed. The filter housing-associated retention/carrier parts 50 are located in the free-running annular space 70 of the filter element-associated retention/carrier device 48. Between the side of the limit stops 66 of the filter element-associated retention/carrier parts 54 that axially faces away from the cover-side end plate 36 and the corresponding filter housing-associated retention/carrier parts 50, there is an axially extending gap 76, which is recognizable, for example, in FIG. 5.

The filter housing-associated retention/carrier parts 50 can run free relative to the filter element 24 in the circumferential direction when the housing cover 15 in the free-running annular space 70 is turned further. As a result, the screwing movement of the housing cover 15 in the closing rotational direction 74 does not cause the filter element 24 to turn. The filter element 24 remains in a rotational fixed orientation in the housing pot 14, while the housing cover 15 is brought into its end position in the housing pot 14 by the screwing movement in the closing rotational direction 74. The filter element 24 is only axially pressed into the housing pot 14. Therefore, the ring seal 30, which is located between the filter element 24 and the housing pot 14, does not rub against one of the components during the relative movement between the housing cover 15 and the housing pot 14.

In the correct installation state, the bypass valve 32 closes off the opening of the element interior space 38 toward the housing cover 15. Only when an overpressure occurs, for example, in case the filter medium 34 is blocked, the bypass valve 32 opens and in this way enables a bypass—which is not of further interest in this case—for the engine oil to go around the filter medium 34.

To remove the filter element 24, the housing cover 15 is unscrewed from the housing pot 14 by a screwing movement counter to the closing rotational direction 74 and counter to the circumferential direction 64 of the filter element 24 relative to the housing pot 14. When this happens, the filter housing-associated retention/carrier parts 50 and the corresponding filter element-associated retention/carrier parts 54 hook back in. The retention/carrier system 44 is activated in this way and is loadable for axial tension. By virtue of the limit stops 66 of the filter element-associated retention/carrier parts 54, the retention/carrier system 44 is also mechanically loadable with respect to the rotation counter to the circumferential direction 64 of the filter element 24. In this way, the filter element 24 is carried along with the housing cover 15 when separated from the housing pot 14.

After separation of the screw connection 27, the housing cover 15 is removed together with the filter element 24 from the housing pot 14. The filter element 24 is turned opposite to the element circumferential direction 64 relative to the housing cover 15, so that the filter housing-associated retention/carrier parts 50 are guided into the through holes 60. Then, the filter element 24 is axially extracted from the housing cover 15.

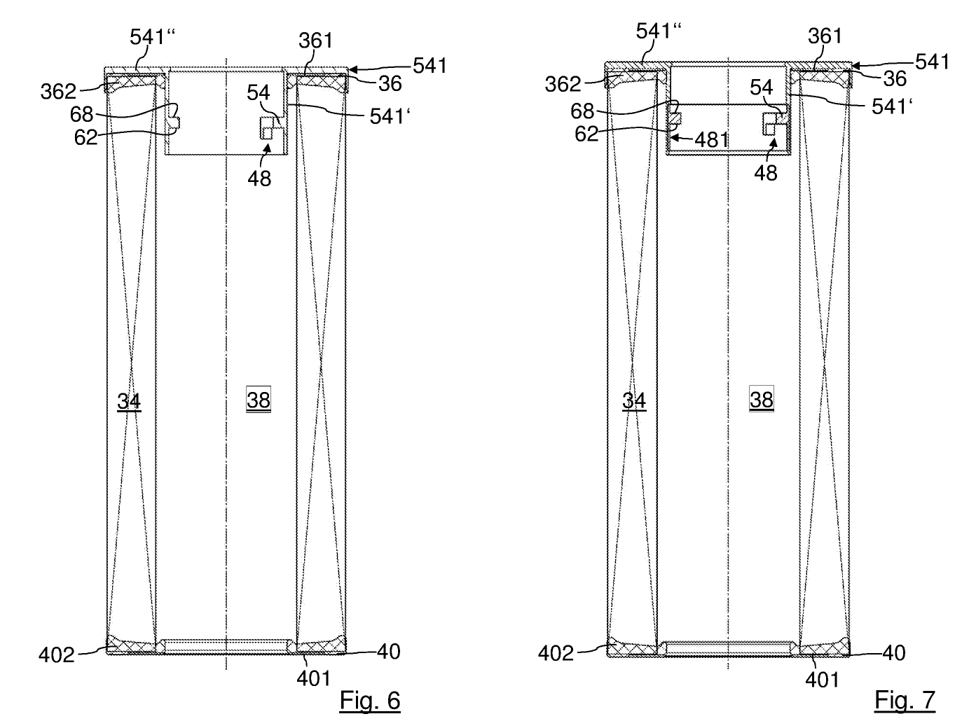

Shown in FIGS. 6 and 7 are further embodiments of the hollow filter element 24 that differ from the previously described embodiments in that the filter element-associated retention/carrier device 48 comprising the filter element-associated retention/carrier parts 54 is not present on the central tube, but instead on a separate carrier ring 541. The shown filter elements 24 are filter elements without an element-fixed central tube; they can be used in particular in filter devices that have a housing-fixed central tube in order to achieve the required stability against pressure differential.

The carrier ring 541 has, respectively, a collar shape and comprises a cylindrical section 541′, which extends into the element interior space 38, and a disk-shaped section 541″ that rests against the top end plate 36 and is joined thereto, preferably glued, welded or clipped on. Other types of connections, detachable or non-detachable, are possible. This design provides the advantage that even hollow filter elements 24 without central tube can be equipped with a filter element-associated retention/carrier device 48 that is located in the element interior space 38. Furthermore, also hollow filter elements 24 that do not have injection-molded (plastic) end plates, in particular metal-free hollow filter elements having end plates made of a foamed foil material, may be outfitted with a filter element-associated retention/carrier device 48 of this type.

Furthermore, sealing discs 361, 401 that are designed, for example, as felt gaskets are provided for both the top end plate 36 and bottom end plate 40. The reference characters 362, 402 each designate foaming areas of the top end plate 36 and bottom end plate 40 that are made necessary by the manufacture of the end plates 36, 40 of a foam-in-place plastic material; during the foaming process, foamed plastic material penetrates into the spaces between the pleats and thereby connects the pleats to the end plates 36, 40, in particular in an integrally fastened manner.

The hollow filter element 24 shown in FIG. 7 has the further peculiarity that the filter element-associated retention/carrier device is not directly present on the carrier ring 541, but instead on a separate retention/carrier ring 481 that is rotatably mounted inside the carrier ring 541. More precisely, the retention/carrier ring 481 is inserted in a circumferential groove on an inner surface of the cylindrical section 541′ of the carrier ring 541, so that it cannot fall out when the hollow filter element 24 is not in the installed state. In order to enable the retention/carrier system 44 operation according to the invention, the retention/carrier ring 481 should not be “easily” rotatable in an arbitrary sense, but instead should only be rotatable after a prescribed limiting torque is overcome, which can be achieved, for example, by friction between the surfaces of the carrier ring 541 and retention/carrier ring 481 that are in contact with each other and suitable fit selection. This limiting torque, which is the minimum that must be applied for the rotation of the retention/carrier ring 481 with respect to carrier ring 541, is essentially determined by the torque that is required to bring the filter element-associated retention/carrier parts 54 into engagement with the filter housing-associated retention/carrier parts 50. This design has the advantages that no free-running annular space needs to be provided.

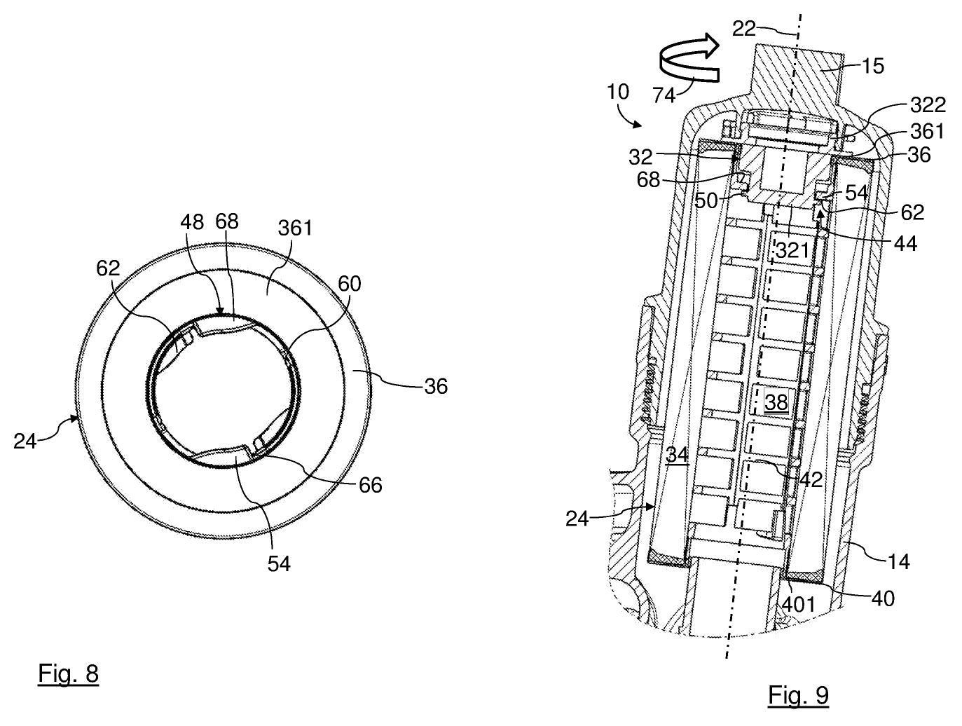

FIG. 8 shows yet another embodiment of the hollow filter element 24 according to the invention, which differs from the previously described designs in that the filter element-associated retention/carrier device 48 present on the inner circumference has only two filter element-associated retention/carrier parts 54 that are evenly distributed around the circumference. Furthermore, the hollow filter element 24 is symmetrically designed along a plane of symmetry running normal to the longitudinal axis, that is, it has a filter element-associated retention/carrier device 48 at each of the two longitudinal side ends; this makes it possible for the hollow filter element 24 to be installable in any desired orientation, because corresponding filter element-associated retention/carrier parts 54, which can be brought into functional engagement with the corresponding filter housing-associated retention/carrier parts 50, are present both on its bottom side and on its top side. In the illustration of FIG. 8, the filter element-associated retention/carrier parts 54 present in the region of the bottom end plate on the central tube 42 (at the rear in the image plane) show through between the two filter element-associated retention/carrier parts 54 present in the region of the top end plate 36 on the central tube 42.

In FIG. 9, reference being had in this context essentially to the description of FIGS. 1 to 5 because the modes of operation essentially correspond, a filter 10 according to the invention is shown according to a further embodiment that comprises the hollow filter element 24 of FIG. 8. However, the depicted embodiment differs by the integration of the free-running action of the filter element-associated retention/carrier device 48 compared to the housing side retention/carrier device 46 of the previously described embodiments. Here it is provided to rotatably mount the bypass valve 32 with its bypass valve housing 321 in the housing cover 15 in order to achieve the previously described free-running property. The bypass valve housing 321 is snap fit by latch noses 322 in the housing cover 15. The clamping force of these latch noses 322 is designed overall in such a way that they can transmit a prescribed limiting torque, i.e., a rotation of the bypass valve housing 321 relative to the housing cover 15 is possible only after this limiting torque is overcome.

This makes it possible, on the one hand, that the filter element-associated retention/carrier parts 54, more precisely its tensile faces 62, are brought into operative contact with the filter housing-associated retention/carrier parts 50 by a rotation of the housing cover 15 relative to the housing pot 14. On the other hand, this provided that the hollow filter element 24 turns together with the housing cover 15 when the latter is unscrewed only when the hollow filter element 24 has been pulled out of the sealing seat on the lower end plate 40 at least far enough that a friction torque occurring there can no longer damage the retention/carrier system 44 with its filter housing-associated retention/carrier parts 50 and filter element-associated retention/carrier parts 54.

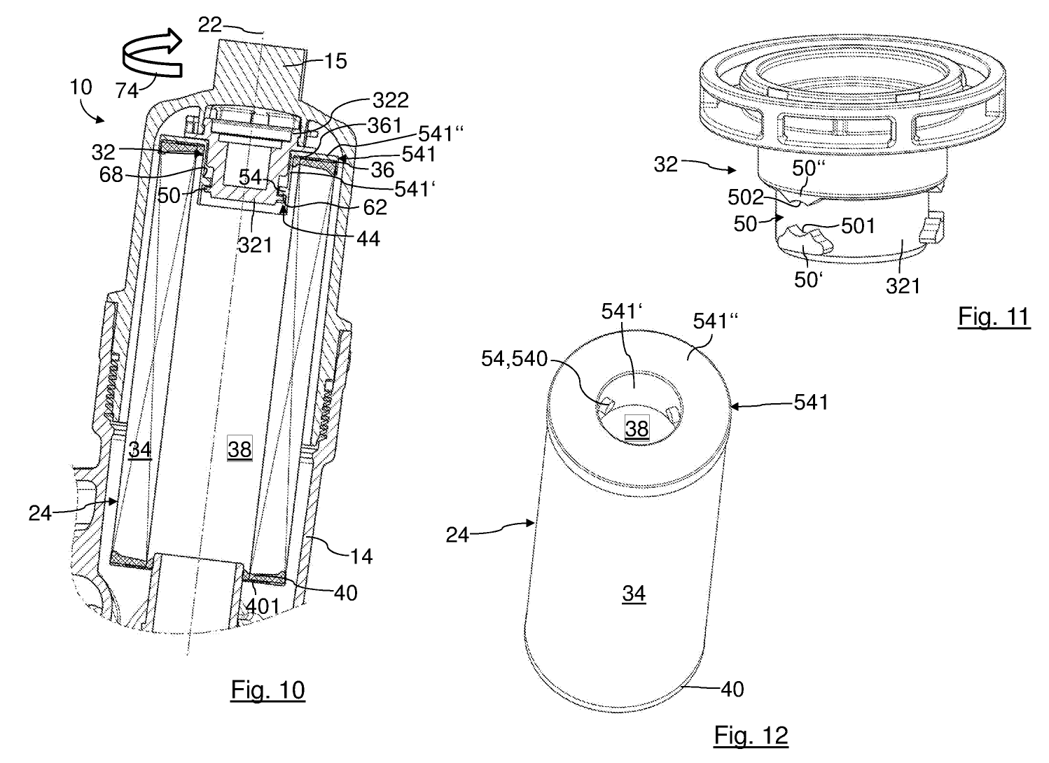

A filter 10 that essentially corresponds to the filter 10 shown in FIG. 9 is shown in FIG. 10; a difference exists only with regard to the filter element 24 used, wherein here it is the filter element 24 shown in FIG. 6, which has no central tube and for which the filter element-associated retention/carrier 48 is present on a separate carrier ring 541. The implementation of the free-running property of the hollow filter element 24 with respect to the housing cover 15 is in turn realized by the bypass valve housing 321, which is rotatably mounted in the housing cover 15; reference is being had to the description of FIG. 9 in this context.

A bypass valve 32 having a bypass valve housing 321 for a filter 10 according to a further embodiment is shown in FIG. 11. The filter housing-associated retention/carrier parts 50 are constructed in this case of one receptacle body 50′ and one clamping body 50″ each, which are spaced at an axial distance from each other. The receptacle body 50′ has a receptacle groove 501, in which a radially extending pin 540 that is present on the hollow filter element 24 (see FIG. 12) can be accommodated. A clamping surface 502 is provided on the clamping body 50″ that faces the receptacle body 50′ and that can have a clamping effect on the pin 540 in a state in which the pin 540 is held in the receptacle groove 501. An axial protuberance is provided for both circumferential directions adjacent to the receptacle groove 501 by means of which the pin 540 of the hollow filter element 24 can be held. A space between the protuberances and the axially opposite clamping surface 502 is dimensioned in such a way that the pin 540 can slide across it by the effect of a prescribed engagement torque in order to be held in the receptacle groove 501.

Finally, a hollow filter element 24 according to this further embodiment is shown in FIG. 12. Four pins 540, which can have a cylindrical cross-section and extend radially inward are provided here as filter element-associated retention/carrier parts 54. The filter element-associated retention/carrier parts 54 are present on a carrier ring 541 or, more precisely, on its cylindrical section 541′. The design of the filter element-associated retention/carrier parts 54 as pins 540 has the advantage that, in the manufacture of the carrier ring 541, they can easily be demolded as plastic injection-molded parts, for example, using a rotary core. However, the design of the filter element-associated retention/carrier parts 54 as pins 540 is not limited to an embodiment having a carrier ring 541; rather, they can also be combined in embodiments of the hollow filter element 24 that have a central tube.

While specific embodiments of the invention have been shown and described in detail to illustrate the inventive principles, it will be understood that the invention may be embodied otherwise without departing from such principles.

What is claimed is:

1. A hollow filter element of a fluid filter configured to be exchangeably arranged in a filter housing of the fluid filter, wherein the filter housing comprises a first housing section and a second housing section, the hollow filter element comprising:
at least one filter element-associated retention/carrier device of a retention/carrier system for retaining and/or carrying the hollow filter element in the first housing section of the filter housing at least during installation and/or removal of the hollow filter element in or from the second housing section of the filter housing, wherein the hollow filter element is configured to be joined with or separated from the first housing section and/or the second housing section by a rotational and/or insertion movement relative to a virtual axis;
wherein the at least one filter element-associated retention/carrier device comprises at least one filter element-associated retention/carrier part extending radially relative to the virtual axis and extending circumferentially over at least a portion of a radially inner circumference of the hollow filter element;
wherein the at least one filter element-associated retention/carrier device comprises, circumferentially adjacent to the at least one filter element-associated retention/carrier part relative to the virtual axis, one or more through holes extending circumferentially relative to the virtual axis and configured to enable at least one filter housing-associated retention/carrier part of at least one filter housing-associated retention/carrier device of the retention/carrier system to pass through axially;
wherein the at least one filter element-associated retention/carrier part comprises a tensile face extending circumferentially and radially, wherein the tensile face is located on a side of the at least one filter element-associated retention/carrier part that is facing axially away, relative to the virtual axis, from an end face of the hollow filter element to be facing the first housing section;
wherein the at least one filter element-associated retention/carrier part, viewed in a defined circumferential direction of the hollow filter element, has a rear side and a front side;
wherein the one or more through holes include a first through hole adjacent to the rear side of the at least one filter element-associated retention/carrier part;
wherein a space axially adjacent to the tensile face is connected on the rear side of the at least one filter element-associated retention/carrier part to the first through hole in a way suitable for guiding through the at least one filter housing-associated retention/carrier part.

2. The hollow filter element according to claim 1, wherein the at least one filter element-associated retention/carrier part on a side where the tensile face is located comprises a limit stop that delimits the tensile face at the front side of the at least one filter element-associated retention/carrier part.

3. The hollow filter element according to claim 1, wherein the at least one filter element-associated retention/carrier device comprises a free-running annular space configured to accommodate the at least one filter housing-associated retention/carrier part, wherein the free-running annular space extends circumferentially contiguously relative to the virtual axis and is located, when viewed axially relative to the virtual axis from the end face of the hollow filter element to be facing the first housing section, behind the at least one filter element-associated retention/carrier part, wherein the free-running annular space is connected to the one or more through holes of the at least one filter element-associated retention/carrier device in a way suitable for guiding through the at least one filter housing-associated retention/carrier part.

4. The hollow filter element according to claim 3, wherein the one or more through holes include a second through hole adjacent to the front side of the at least one filter element-associated retention/carrier part, wherein the front side of the at least one filter element-associated retention/carrier part comprises a free-running guide configured to guide the at least one filter housing-associated retention/carrier part from the second through hole into and/or out of the free-running annular space.

5. The hollow filter element according to claim 1, wherein the at least one filter element-associated retention/carrier device is arranged at least partially in an interior space of the hollow filter element so as to be accessible from the exterior of the hollow filter element.

6. The hollow filter element according to claim 1, wherein the at least one filter element-associated retention/carrier part is arranged at least partially in an interior space of the hollow filter element so as to be accessible from the exterior of the hollow filter element.

7. The hollow filter element according to claim 1, wherein the at least one filter element-associated retention/carrier device is directly or indirectly connected in a detachable manner or in a non-destruction-free detachable manner to at least one supporting element selected from the group consisting of a support body of the hollow filter element, an end body of the hollow filter element, and a carrier part of the hollow filter element.

8. The hollow filter element according to claim 7, wherein the support body is a support tube, wherein the end body is an end plate, and wherein the carrier part is a carrier ring.

9. The hollow filter element according to claim 7, wherein the at least one filter element-associated retention/carrier device is connected to the carrier ring, wherein the carrier ring is configured as a collar, and wherein the collar is detachably or non-detachably joined to the end body.

10. The hollow filter element according claim 1, further comprising a retention/carrier ring rotatably mounted on a radially inward circumference of the hollow filter element, wherein the filter element-associated retention/carrier device is disposed on the retention/carrier ring.

11. The hollow filter element according to claim 10, wherein the retention/carrier ring is held in a circumferential groove provided on an interior surface of a central tube of the hollow filter element or of a carrier ring of the hollow filter element.

12. The hollow filter element according to claim 11, wherein the retention/carrier ring is rotatable in relation to the central tube or the carrier ring only after a prescribed limiting torque is overcome.

13. The hollow filter element according to claim 1, wherein the retention/carrier system of which the at least one filter element-associated retention/carrier part is a component is a bayonet-closure-type retention/carrier system.

14. The hollow filter element according to claim 1, wherein at least two of the filter element-associated retention/carrier parts are provided and arranged in an even or an uneven circumferential distribution relative to the virtual axis.

15. The hollow filter element according to claim 1, wherein the at least one filter element-associated retention/carrier part on a side facing axially away from the at least one tensile face relative to the virtual axis is provided with a guide surface configured to guide the at least one filter housing-associated retention/carrier part for mating the first housing section and the hollow filter element.

16. The hollow filter element according to claim 15, wherein, when viewed in the defined circumferential direction, an axial distance of the guide surface, measured relative to the virtual axis, increases relative to the end face of the hollow filter element to be facing the first housing section.

17. The hollow filter element according to claim 1, wherein:
the at least one filter element-associated retention/carrier part comprises an essentially radially extending pin and the at least one filter housing-associated retention/carrier part of the retention/carrier system comprises a receptacle groove extending radially and corresponding to an outer contour of the essentially radially extending pin, or
the at least one filter housing-associated retention/carrier part comprises an essentially radially extending pin and the at least one filter element-associated retention/carrier part of the retention/carrier system comprises a receptacle groove extending radially and corresponding to an outer contour of the essentially radially extending pin.

18. The hollow filter element according to claim 17, wherein the at least one filter element-associated retention/carrier part provided with the receptacle groove or the filter housing-associated retention/carrier part provided with the receptacle groove comprises at least one clamping face that is axially spaced apart from the receptacle groove.

19. The hollow filter element according to claim 18, wherein the receptacle groove is provided on a receptacle body and the clamping surface is provided on a clamping body that is embodied separate from the receptacle body.

20. The hollow filter element according to claim 1, further comprising a valve seat wherein the at least one filter element-associated retention/carrier part is realized in the vicinity of, on or together with the valve seat valve.

21. The hollow filter element according to claim 1, further comprising a bypass valve, wherein the at least one filter element-associated retention/carrier part is realized in the vicinity of, on or together with the bypass valve or a housing of the bypass valve.

22. A fluid filter comprising:
a filter housing comprising at least a first housing section and a second housing section, wherein the first and the second housing sections are at least partly separable from one another for opening the filter housing;
at least one hollow filter element that is exchangeably arranged in the filter housing;
a retention/carrier system for retaining and/or carrying the at least one hollow filter element in the first housing section of the filter housing at least during installation and/or removal of the hollow filter element in or from the second housing section of the filter housing, wherein the at least one hollow filter element is configured to be joined with or separated from the first housing section and/or the second housing section by a rotational and/or insertion movement relative to a virtual axis;
wherein the retention/carrier system comprises at least one filter housing-associated retention/carrier device disposed on the first housing section and further comprises at least one filter element-associated retention/carrier device disposed on the at least one hollow filter element;
wherein the at least one filter element-associated retention/carrier device comprises at least one filter element-associated retention/carrier part extending radially relative to the virtual axis and extending circumferentially over at least a portion of a radially inner circumference of the hollow filter element;
wherein the at least one filter element-associated retention/carrier device comprises, circumferentially adjacent to the at least one filter element-associated retention/carrier part relative to the virtual axis, one or more through holes extending circumferentially relative to the virtual axis and configured to enable at least one filter housing-associated retention/carrier part of at least one filter housing-associated retention/carrier device of the retention/carrier system to pass through axially;
wherein the at least one filter element-associated retention/carrier part comprises a tensile face extending circumferentially and radially, wherein the tensile face is located on a side of the at least one filter element-associated retention/carrier part that is facing axially away, relative to the virtual axis, from an end face of the hollow filter element to be facing the first housing section;
wherein the at least one filter element-associated retention/carrier part, viewed in a defined circumferential direction of the hollow filter element, has a rear side and a front side;
wherein the one or more through holes include a first through hole adjacent to the rear side of the at least one filter element-associated retention/carrier part;
wherein a space axially adjacent to the tensile face is connected on the rear side of the at least one filter element-associated retention/carrier part to the first through hole in a way suitable for guiding through the at least one filter housing-associated retention/carrier part.

23. The filter according to claim 22, wherein the first housing section is a housing cover and the housing cover comprises a bypass valve comprising a bypass valve housing, wherein the at least one filter housing-associated retention/carrier device is disposed on the bypass valve housing.

24. The filter according to claim 23, wherein the at least one filter housing-associated retention/carrier part is disposed on a radially outer face of the bypass valve housing.

25. The filter according to claim 23, wherein the bypass valve housing is rotatable relative to the housing cover only after a prescribed limiting torque is overcome.

26. A first housing section of a filter housing of a filter, wherein the filter housing is configured to be joined to at least one second housing section for sealing off the filter housing and to be separated at least partially from the at least one second housing section for opening the filter housing, wherein the first housing section comprises:
at least one filter housing-associated retention/carrier device of a retention/carrier system for retaining and/or carrying a hollow filter element in the first housing section at least during installation and/or removal of the hollow filter element in or from the second housing section, wherein the first housing section is configured to be joined with or separated from the hollow filter element and/or the second housing section by a rotational and/or insertion movement relative to a virtual axis;
wherein the at least one filter housing-associated retention/carrier device comprises at least one filter housing-associated retention/carrier part extending radially relative to the virtual axis and circumferentially over at least a portion of a circumference of the at least one filter housing-associated retention/carrier device;
wherein the at least one filter housing-associated retention/carrier device comprises, circumferentially adjacent to the at least one filter housing-associated retention carrier part relative to the virtual axis, at least one gap extending circumferentially relative to the virtual axis and configured to enable at least one corresponding filter element-associated retention/carrier part of at least one filter element-associated retention/carrier device of the retention/carrier system to axially pass through;
wherein the first housing section comprises a bypass valve and wherein the at least one filter housing-associated retention/carrier device is disposed on the bypass valve.

27. The first housing section according to claim 26, wherein the first housing section is a housing cover configured to close off the second housing section that is a housing pot.
